(19) United States
(12) Patent Application Publication
(10) Pub. No.: US 2017/0069168 A1
(43) Pub. Date: Mar. 9, 2017

(54) SYSTEM AND METHOD FOR A USER-TO-USER MARKETPLACE FOR ONLINE CASINO GAMES

(71) Applicant: Janet Rush, Brooklyn, NY (US)

(72) Inventor: Janet Rush, Brooklyn, NY (US)

(21) Appl. No.: 15/257,231

(22) Filed: Sep. 6, 2016

Related U.S. Application Data
(60) Provisional application No. 62/214,515, filed on Sep. 4, 2015.

(51) Int. Cl. G07F 17/32

(52) U.S. Cl. CPC G07F 17/3248; G07F 17/3241; G07F 17/3272; G07F 17/3209; G07F 17/323

(57) ABSTRACT

The present disclosure is directed at a system and method for implementing a user-to-user market place in a social casino gaming platform. More specifically, the system and method of the present disclosure enables users on a social casino gaming platform to purchase chips directly from other users on the social casino gaming platform. In an aspect of the present disclosure, the system and method of the present disclosure only allows chips to be sold between users of the online social casino gaming platform in accordance with certain restrictions. In another aspect of the present disclosure, the system and method of the present disclosure determines a new user's tier status based on the new user's account history in other online social casino platforms.

### PRIORITY

This application claims priority to U.S. Provisional Patent Application Ser. No. 62/214,515 filed Sep. 4, 2015, entitled “SYSTEM AND METHOD FOR A USER-TO-USER MARKETPLACE FOR ONLINE CASINO GAMES”, the contents of which are hereby incorporated by reference in its entirety.

### TECHNICAL FIELD

The present disclosure generally relates to online casino games. More particularly, the present disclosure is related to a system and method for a user-to-user marketplace for online casino games.

BACKGROUND

Any background information described herein is intended to introduce the reader to various aspects of art, which may be related to the present embodiments that are described below. This discussion is believed to be helpful in providing the reader with background information to facilitate a better understanding of the various aspects of the present disclosure. Accordingly, it should be understood that these statements are to be read in this light.

In recent years, online gaming has seen a dramatic increase in popularity. For example, there are many online casino style games, such as blackjack, roulette, and Texas hold'em. Although regulations exist that require casino (i.e., gambling) games that provide a payout to be conducted at specific, physical locations, amusement-only casino games (i.e., casino games with no payout) may be conducted in a public venue like the Internet. Online casino games with no payout are sometimes referred to as social casinos. The genre of social casino gaming has been one of the fastest growing gaming genres in recent years. Social casino gaming is offered across various platforms, such as PCs and various mobile devices having access to the Internet. One of the big draws to social casino gaming is the rich environment for interactions between users all over the world.

Many gaming companies offer a suite of social casino games where users can sign up and are given a predetermined amount of free chips to play with. When a user runs out of chips, if the user desires to continue playing, the user can either wait a predetermined amount of time (e.g., a day or a week) to be given more free chips, or the user may purchase more chips to continue playing immediately. To incentivize the purchase of chips, several gaming companies have structured social casino gaming platforms in “tiered” systems. In tiered systems, users in higher tiers receive certain rewards or perks associated with attaining entry to a higher tier. For example, users in higher tiers may receive a better rate when buying chips than users in lower tiers. Alternatively, users in higher tiers may receive free chips on a more frequent basis. The advancement to higher tiers may be based on the total amount of time spent playing social casino games and/or a predetermined amount of total chips have been bought.

Although tiered systems are meant to incentivize increased periods of game play and chip purchases, there are several drawbacks. For instance, if the prices to purchase chips for entry-level tiers are too expensive, users may be discouraged from purchasing additional chips when the free chips run out. Furthermore, users in lower tiers may make agreements to purchase chips directly from users in higher tiers, bypassing the gaming platform altogether. If this occurs, a gaming company may lose significant revenue in chip transactions that occur outside the gaming platform. Therefore, a need exists for a system and method for an improved social casino gaming experience on online gaming platforms.

### SUMMARY

The present disclosure is directed at a system and method for implementing a user-to-user market place in a social casino gaming platform. More specifically, the system and method of the present disclosure enables users on a social casino gaming platform to purchase chips directly from other users on the social casino gaming platform. In aspect of the present disclosure, the system and method of the present disclosure only allows chips to be sold between users of the online social casino gaming platform in accordance with certain restrictions. In another aspect of the present disclosure, the system and method of the present disclosure determines a new user's tier status based on the new user's account history in other online social casino platforms. The system and method of the present disclosure records all user-to-user transactions that take place on the market place and enables the online social gaming casino platform to monitor, regulate, and profit from user-to-user chip transactions.

In another aspect of the present disclosure, a system for an online social casino platform is provided including: a communication interface coupled to a network, the network further coupled to a plurality of user computing devices, each user computing device associated with one of a plurality of users; a user account module configured to store information associated with each user of the plurality of users, wherein at least some of the information includes the number of chips and the amount of money each user of the plurality of users currently has in each user's account; a chip offer module configured to receive at least one sell offer from at least one first user of the plurality of users to sell chips belonging to the at least one first user, the at least one sell offer being for a first price; an order module configured to receive at least one buy order from at least one second user of the plurality of users to buy the chips being offered in the at least one sell offer by the at least one first user; and a transaction module configured to receive the at least one sell offer and the at least one buy order and determine if at least one restriction associated with the at least one sell offer and/or the at least one buy offer exists, and wherein if the transaction module determines that the at least one restriction does not exist, the transaction module completes a first transaction, the first transaction including the transaction module transferring the chips being offered in the at least one sell offer from a first user account associated with the first user to a second user account associated with the second user, the first and second account stored in the user account module, crediting the first account for the first price, and debiting the second account for the first price.

In another aspect of the present disclosure, a method is provided including receiving, by a chip offer module, at least one sell offer from at least one first user of a plurality of users to sell chips belonging to the at least one first user, the at least one sell offer being for a first price; receiving, by an order module, at least one buy order from at least one second user of the plurality of users to buy the chips being offered in the at least one sell offer by the at least one first user; receiving, by a transaction module, the at least one sell offer and the at least one buy order; determining, by the transaction module, if at least one restriction associated with the at least one sell offer and/or the at least one buy offer exists; and completing, by the transaction module, a first transaction if it is determined that the at least one restriction does not exist, the first transaction including the transaction module transferring the chips being offered in the at least one sell offer from a first user account associated with the first user to a second user account associated with the second user, crediting the first account for the first price, and debiting the second account for the first price.

In another aspect of the present disclosure, a method is provided including receiving a request from a new user to register for a new account on a first online social casino platform; sending a first message to the new user asking the new user if the new user has any preexisting accounts with social casino platforms other than the first online social casino platform; receiving a response from the new user to the first message; registering the new user in a first player tier if the response indicates the new user does not have any preexisting accounts with other social casino platforms; sending a second message to the new user requesting the credentials of the new user for any preexisting accounts with other social casino platforms if the response to the first message indicates the new user does have any preexisting accounts with other social casino platforms; receiving the credentials for any preexisting accounts from the new user; retrieving the new user's account history for each of the preexisting accounts with other social casino platforms; determining the new user's tier for the first online social casino platform based on the retrieved account history, the determined tier being a tier above the first tier; and registering the new user to the first online social casino platform in the determined tier.

### BRIEF DESCRIPTION OF THE DRAWINGS

These, and other aspects, features and advantages of the present disclosure will be described or become apparent from the following detailed description of the preferred embodiments, which is to be read in connection with the accompanying drawings.

FIG. 1 is a system for allowing a plurality of users to play social casino games in accordance with an embodiment of the present disclosure.

FIG. 2 is an illustration of a user interface for a user-to-user marketplace in accordance with an embodiment of the present disclosure.

FIG. 3 is a flow chart of a method for a user to purchase chips from another user on a social casino gaming platform in accordance with an embodiment of the present disclosure.

FIG. 4 is a flow chart of a method for a user to sell chips to another user on a social casino gaming platform in accordance with an embodiment of the present disclosure.

FIG. 5 is a flow chart of a method for determining the tier status of a new user in accordance with an embodiment of the present disclosure

It should be understood that the drawing(s) are for purposes of illustrating the concepts of the disclosure and is not necessarily the only possible configuration for illustrating the disclosure.

### DESCRIPTION OF EMBODIMENTS

It also should be understood that the elements shown in the figures may be implemented in various forms of hardware, software or combinations thereof. Preferably, these elements are implemented in a combination of hardware and software on one or more appropriately programmed general-purpose devices, which may include a processor, memory and input/output interfaces. Herein, the phrase “coupled” is defined to mean directly connected to or indirectly connected with through one or more intermediate components. Such intermediate components may include both hardware and software based components.

The present description illustrates the principles of the present disclosure. It will thus be appreciated that those skilled in the art will be able to devise various arrangements that, although not explicitly described or shown herein, embody the principles of the disclosure and are included within its scope.

All examples and conditional language recited herein are intended for educational purposes to aid the reader in understanding the principles of the disclosure and the concepts contributed by the inventor to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the principles of the disclosure. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, read only memory (ROM) for storing software, random access memory (RAM), and nonvolatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The disclosure as defined by such claims resides in the fact that the functionalities provided by the various recited means are combined and brought together in the manner which the claims call for. It is thus regarded that any means that can provide those functionalities are equivalent to those shown herein.

The present disclosure is directed at a system and method for implementing a user-to-user market place in a social casino gaming platform. More specifically, the system and method of the present disclosure enables users on a social casino gaming platform to purchase chips directly from other users on the social casino gaming platform. In one embodiment, the system and method of the present disclosure only allows chips to be sold between users of the online social casino gaming platform in accordance with certain restrictions. In another embodiment, the system and method of the present disclosure determines a new user's tier status based on the new user's account history in other online social casino platforms. The system and method of the present disclosure records all user-to-user transactions that take place on the market place and enables an online social gaming casino platform to monitor, regulate, and profit from user-to-user chip transactions.

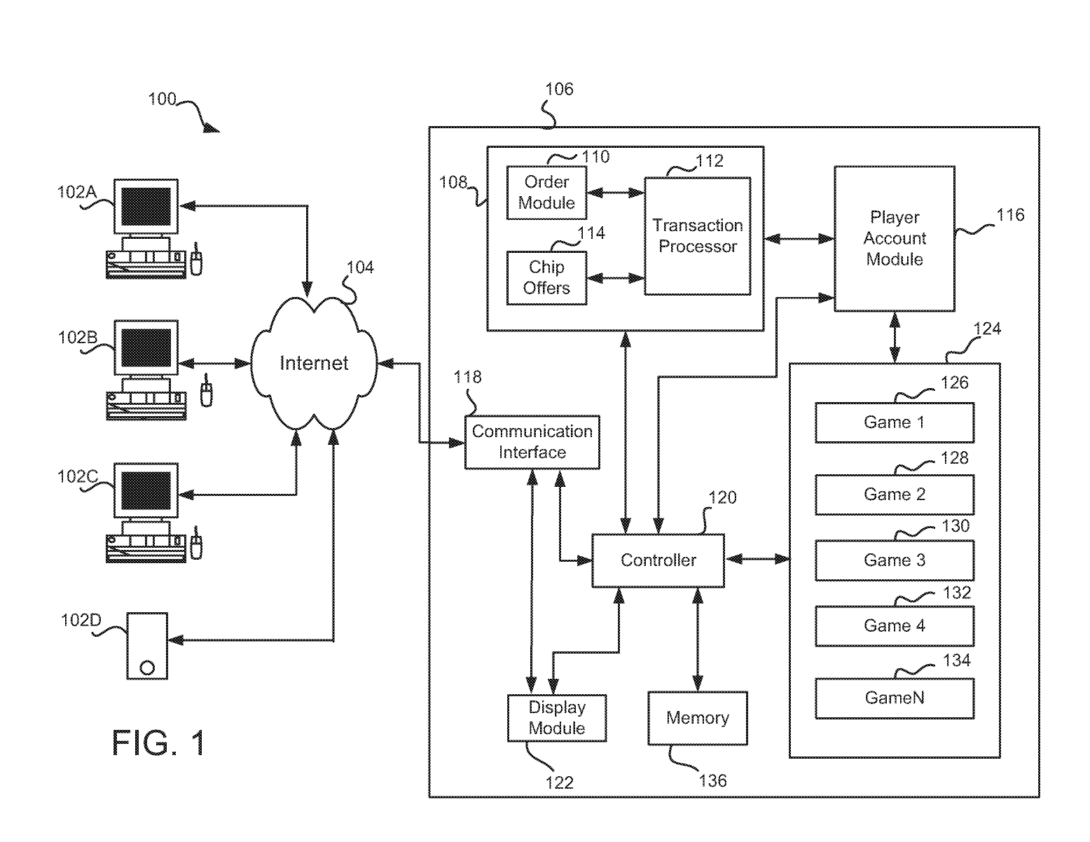

Turning now to the drawings and referring initially to FIG. 1, a system 100 for allowing a plurality of users to play online social casino games is shown in accordance with an embodiment of the present disclosure. System 100 includes user computing devices 102A, B, C, and D that are coupled to online social casino system 106 via a network 104. It is to be appreciated that network 104 may be a network such as the Internet or any other suitable telecommunications network that enables user computing devices 102A-D to communicate with online social casino system 106. It is also to be appreciated that user computing device 102 may be a personal computer, such as user computing devices 102A-C, a smart phone or tablet, such as user computing device 102D, or any other suitable computing device that has suitable display and processing capabilities and can be connected to a telecommunications network.

Online social casino system 106 includes user marketplace 108, user or player account module 116, communication interface 118, controller 120, display module 122, gaming module 124, and memory 136. As seen in FIG. 1, communication interface 118 is coupled to display module 122 and controller 120; controller 120 is coupled to user marketplace 108, player account module 116, gaming module 124, display module 122, and memory 136; user marketplace 108 is coupled to player account module 116; and player account module 116 is coupled to gaming module 124. It is to be appreciated that the online social casino system 106 of the present disclosure may be implemented in hardware, software, firmware, or any combinations thereof. In some embodiments, the online social casino system 106 may be implemented in software or firmware that is stored on a memory device (e.g., a memory device) and that is executable by a suitable instruction execution system (e.g., a processing device). In some embodiments, the various modules (e.g., modules 108, 110, 112, 114, 116, 118, 120, 122, 124, 136) may be implemented in hardware using, for example, discrete logic circuitry, an application specific integrated circuit (ASIC), a programmable gate array (PGA), a field programmable gate array (FPGA), or any combinations thereof.

Each user computing device 102 is configured to transmit and receive data to and from online social casino system 106 via network 104 to enable a user to play an online social casino game on their computing device 102. Specifically, communication interface 118 in online social casino system 106 is configured to transmit and receive data to and from user computing devices 102. Any data received by communication interface 118 is transmitted to controller 120. It is to be appreciated that controller 120 includes a processor capable of executing instructions stored either in controller 120 or memory 136. Controller 120 is also configured to control other components in online social casino system 106. It is also to be appreciated that in some embodiments controller 120 may contain more than one processor.

As stated above, controller 120 is also coupled to player account module 116. Player account module 116 contains a wide variety of user related information, such as, but not limited to, the user's real name, username, email, chip balance (i.e., amount of chips the user has in his/her account), payment information (i.e., paypal, debit/credit cards, etc.) for purchasing account credit, account balance (i.e., amount of account credit available for purchasing chips). Additionally, player account module 116 may include player profile information and statistics associated with a user's account such as player tier, perks/rewards associated with the user's player tier, duration of time spent playing social casino games on online social casino system 106, frequency of games played, frequency of chip purchases, etc. It is to be appreciated that listed information above is only a small subset of possible information that may be stored in player account module 116 and that many more statistics and user related data may be stored in player account module 116. It is to be appreciated that in alternative embodiments some or all of the information stated above may be stored remotely from online social casino system 106, and may be accessed via network 104 and communication interface 118.

Controller 120 and player account module 116 are both coupled to gaming module 124. Gaming module 124 is configured to host a plurality of casino-style games, such as games 126, 128, 130, 132, and 134. It is to be appreciated that the amount of games shown in gaming module 124 is merely illustrative and that gaming module 124 may host many more games than shown in FIG. 1. Games 126, 128, 130, 132, and 134 may each be a virtual casino room of a different casino-style game such as, but not limited to, blackjack, various poker games, roulette, etc.

Controller 120 is also coupled to display module 122. Display module 122 is configured to receive information from user marketplace 108, player account module 116, gaming module 124 via controller 120, and other modules of system 106. Information received by display module 122 is then processed and a graphical user interface (e.g., a webpage) is generated. The graphical user interface may then be transmitted to communication interface 118 directly from display module 122 or via controller 120. Once received by communication interface 118, the graphical user interface can be transmitted to a user computing device 102 and shown on a display on a user computing device 102.

As stated above, many online social casino platforms have implemented “tiered” structures to incentivize more frequent chip purchases by users. Users in higher tiers often receive perks associated with attaining higher tier status. For example, a user in a first tier may pay $100 for 2.5 million chips, a user in a second tier may get 5 million chips for $100, while a user in a third tier may get 7.5 million chips for $100, and a user in a fourth tier may get 10 million chips for $100. It is to be appreciated that more tiers may exist and various pricing structures for chips are possible and the teachings of the present disclosure are equally applicable to each of the various tiers and price structures.

As is evident in above example, a user in a first tier must pay significantly more money to get the same amount of chips as a user in the third or fourth tier. It is to be appreciated that there may be additional perks associated with attaining a higher tier status. For example, as stated above, each user may get a certain amount of free chips (called chip bonuses) on a periodic basis (e.g., once every 30 minutes or once every day or month). Users in higher tiers may receive chip bonuses more frequently than users in lower tiers. Additionally, users in higher tiers may have “multipliers” associated with a chip purchases or chip bonuses. Chip multipliers are specific periods where any purchased chips or chip bonuses received are multiplied by a multiplier. Users in higher tiers may have higher multipliers than users in lower tiers. Multipliers may even be compounded with already existing chip purchase rates. It is to be appreciated that many more perks may be implemented in a tiered structure for an online social casino gaming platform and the above description is merely illustrative of a few possible perks.

Higher tiers may be achieved after a specific duration of play or a specific amount of chips have been purchased. As a result, attaining higher tier status may require a significant amount of time and money on the part of a given user. Although the tiered structure is meant to incentivize customer loyalty and additional chip purchases, the tiered structure has also created a “black market” for chips. Users in lower tiers may not be able to afford to buy the amount of chips necessary to play the social casino games that they like, and therefore, instead of purchasing chips through the social gaming platform, users in lower tiers may resort to buying chips outside the social gaming platform directly from users in higher tiers. Lower tiered users buying chips from higher tiered users are able to buy chips at a significantly lower price than the lower tiered users would be able to otherwise (i.e., buying chips using their own lower tier status).

When lower tiered users buy chips directly from higher tiered users on the “black market,” the online social casino gaming platform loses significant annual revenue. Furthermore, lower tiered users who do not purchase directly from higher tiered users on the “black market,” may become discouraged and play the online casino games less or not at all. Therefore, the total number of users playing on the gaming platform can be significantly reduced by the tiered structure.

It is to be appreciated that in some online social casino platforms, “black market” sales of chips occur through the exchange of “casino gold” or “virtual items.” Casino gold (or virtual items) may be purchased via a store on the online social casino platform by the users of the online social casino platform. The casino gold may be gifted by one user to another user, or alternatively, the gold may be used to gift chips to another user directly. There is often no limit on how much gold one player may gift to another, or how many chips can be purchased using gold to gift to another payer. These virtual items or casino gold are currently one of the main methods used for the sale of chips by higher tiered users to lower tiered users. For example, oftentimes a user of a lower tier will pay a user of a higher tier using an e-commerce website. Then, the higher tier player will use their gold and perks (as described above) to purchase chips to gift to the lower tier player. It is to be appreciated that the above described method of achieving a “black market” sale of chips is merely exemplary and there are many other ways that “black market” sales of chips may occur.

To mitigate the negative affects of the tiered structure on lower tiered users, the present disclosure implements a user-to-user marketplace, where lower tiered users may purchase chips from higher tiered users directly on the online gaming platform. It is to be appreciated that in some embodiments of the present disclosure, casino gold or virtual items (as described above) may also be sold on the user-to-user marketplace that will be described below. The implementation of the user-to-user marketplace disclosed in the present disclosure is advantageous for online social casino gaming platforms because it allows the gaming platforms to profit off of user-to-user transactions that would have otherwise taken place on the “black market.” Also, the user-to-user marketplace allows the online social casino gaming platforms to monitor the transactions and place certain rules and restrictions (as desired) as will be described in greater detail below.

The user-to-user marketplace described above is implemented through user marketplace 108, shown in FIG. 1. User marketplace 108 includes order module 110, chip offer module 114, and transaction module 112. In the presently described embodiment, a user may offer to sell a desired number of chips to other users for a chosen price or alternatively choose to buy chips being offered by other users. Offers to sell chips, or requests to buy chips may be achieved by selecting either a sell or a buy option on a graphical user interface being displayed on a computing device 102, where the graphical user interface is generated by display module 122. Chip offer module 114 is configured to receive offers to sell chips. Order module 110 is configured to receive requests to buy chips. It is to be appreciated that in some embodiments, chip offer module 114 and order module 110 may be configured to include options to sell casino gold or virtual items, in addition to, or instead of chips.

Both order module 110 and chip offer module 114 are coupled to transaction module 112. Transaction module 112 is configured to receive and process offers to sell and requests to buy chips from chip offer module 114 and order module 110. Transaction module 112 is also coupled to player account module 116. Transaction module 112 is configured to access user account information from player account module 116, such as account balance, chip balance, and payment information. Transaction module 112 may then use the information accessed from player account module 116 to process received offers to sell and requests to buy. It is to be appreciated that transaction module 112 is configured to process offers to sell and requests to buy in accordance with predefined rules and restrictions, as will be described below. The rules or restrictions may be stored in transaction module 112, controller 120, or memory 136. Also, if a transaction is completed, transaction module 112 is configured to update player account information stored in player account module 116, such as account balance, chip balance, and any other relevant account information.

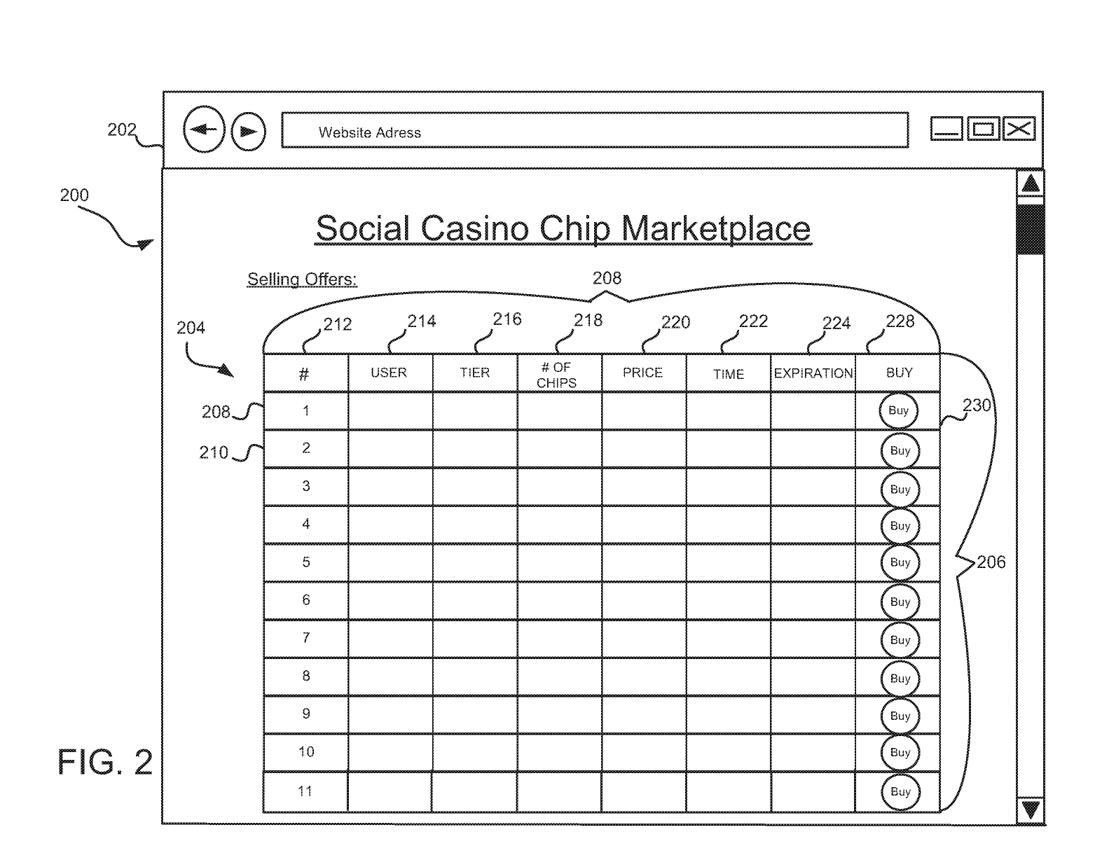

Turning now to FIG. 2, an exemplary graphical user interface (“GUI”) 200 of a user marketplace is shown in accordance with an embodiment of the present disclosure. It is to be appreciated that graphical user interface 200 may be generated in display module 122 and accessed via communication interface 118 and network 104 to be displayed on a user computing device 102.

GUI 200 is displayed on a browser 202 on a user computing device 102. It is to be appreciated that browser 202 may be a mobile browser for a mobile computing device, such as a smartphone or tablet, or browser 202 may be desktop browser for a personal computer or laptop. Furthermore, in another embodiment, GUI 200 may be included in an application specific to online social gaming casino system 106.

GUI 200 includes table 204, where table 204 contains a plurality of rows 206 and columns 208. Rows 206 and columns 208 contain various information associated with chips offered for sale by users on the social casino gaming platform. For example, columns 208 may include a column 212 to indicate the number of different chip offerings made by a seller. Columns 208 may also include columns associated with user-related information, such as, column 214, which includes a user's user name, and column 216, which includes the tier the selling user is in.

Columns 208 also include statistics associated with the chip offerings, such as, column 218, which includes the number of chips being offered for sale, and column 220, which includes the price for the chips being offered in column 218. It is to be appreciated that in some embodiments the price in column 220 may be a price per chip, or alternatively, it may be the price for the total number of chips being offered. Furthermore, it is to be appreciated that in some embodiments the price for the chips being offered may be set by the casino in a fixed structure (i.e., all chip offerings must be the same price per chip), so as to discourage pricing competition in the casino chip marketplace. In these embodiments, chip offer module 114 is configured to require the offers received by users to conform to the fixed price structure chosen by the casino. Furthermore, the chip offer module 114 is configured to send a user a prompt or notification if a received offer from that user does not conform to the fixed price structure, where the notification or prompt will inform the user of the price the user must adhere to. Alternatively, the user will only be given the option of deciding the number of chips to offer for sale rather than also be given the option to decide the price. In other embodiments, the price offered for each chip may be set and chosen by the selling user.

Additionally, columns 208 may also include time-related statistics, such as, column 222, which lists the time the chip offering was posted by the seller, and column 224, which lists the time the offer will expire. It is to be appreciated that time-related statistics may be calculated and/or monitored by one of controller 120, chip offer module 114, and/or transaction module 112. It is to be appreciated that the information for columns 212, 214, 216, 218, 220, 222, and 224 may be stored in a combination of chip offer 114, player account module 116, memory 136, and/or in any other suitable and accessible location.

Columns 208 also include a buy column 228. Buy column 228 includes buy button 230, which a user may press if the user wishes to buy chips associated with one of the rows 204. It is to be appreciated that if buy button is pressed, the user will be taken to another screen (not shown) to complete the chosen transaction. It is to be appreciated that in some embodiments the user will have the option to choose how many chips of the chips being offered in column 218 the user wishes to purchase.

It is also to be appreciated that in some embodiments, columns 208 may include information associated with casino gold or virtual items instead of chips to be sold.

It is to be appreciated that GUI 200 is configured such that the columns 208 in table 204 may be sorted in ascending or descending order. For instance, if a user presses the first cell in the price column 220, table 204 will become sorted in ascending or descending order by price, where row 208 would represent the highest or lowest price and row 210 would present the second highest or lowest price and the ordering will continue for the rows below row 210. It is also to be appreciated that although FIG. 2 shows table 204 including columns 212, 214, 216, 218, 220, 222, 224, and 228, many more columns may be included to display a wider variety of information.

Turning again to FIG. 1, as described above, transaction module 112 is configured to allow buying and selling of chips only if certain predefined rules and restrictions associated with the buying and selling of chips on the user marketplace 108 are satisfied. The rules and restrictions are chosen to create a fair buying and selling environment and to generate revenue for the online social casino gaming platform. For example, in one embodiment, transaction module 112 will only allow a seller to sell his/her chips on the user marketplace 108 if the seller has spent a predetermined amount of money on chip purchases within a predetermined period of time (e.g., in the past month). For example, a seller may only be allowed to sell chips to other users if the seller has purchased $1000 worth of chips in that given month. This restriction would guarantee a steady revenue of chip purchases from players in higher tiers. Alternatively, in one embodiment, transaction module 112 may be configured to only allow a seller to sell his/her chips on the user marketplace 108 if the seller has spent a predetermined amount of money on platform 106 (e.g., on chips, gold, virtual items, etc.) within a predetermined period of time (e.g., a month).

It is to be appreciated that in some embodiments transaction module 112 is configured to allow only players of higher tiers to sell chips on the user marketplace 108. This restriction may incentivize players from lower tiers to continue to purchase more chips and spend more time playing the online casino games so that the players from the lower tiers can achieve the higher tier status necessary to gain the privilege to sell chips to lower tiers. In other embodiments, players from multiple tiers may have the privilege to sell chips on the user marketplace 108.

In another embodiment, transaction module 112 is configured to only allow players to sell chips in predetermined increments or amounts (i.e., in 10 chip amounts, 200 chip amounts, etc.) in a given sell offer. Alternatively, transaction module 112 may be configured to only allow players to sell chips if the number of chips offered is no greater than a certain amount. In other embodiments, transaction module 112 is configured to check player account module 116 to ensure that the seller has a predetermined number of chips above or in addition to the number of chips being sold.

In another embodiment, sellers will receive marketplace credit when they sell chips to buyers. The marketplace credit may be exchanged at a later time for more chips, or alternatively, used to purchase tangible goods offered on the marketplace. Furthermore, credit may be used to redeem rewards like tickets to a show or other rewards associated with any rewards programs available through partnerships between the gaming platform and various rewards companies. In yet another embodiment, transaction module or module 112 may be configured to enforce a time restriction implemented between selling transactions. For example, if a seller completes a chip transaction with a buyer, the seller's ability to sell more chips will be disabled for a predetermined amount of time (e.g., 30 minutes or an hour). This would allow for more sellers to have an opportunity to sell their chips on the marketplace.

It is to be appreciated that the amount of time a seller's selling ability is disabled will be guided by the supply and demand of the chips being sold. For example, in one embodiment, transaction module 112 is configured to monitor the amount of offers received by chip offer module 114 and the amount of buy orders received by order module 110 to determine the length of the time restriction after each transaction. In one embodiment, if transaction module 112 determines that the number of current outstanding offers to sell chips on the marketplace is below a predetermined amount, transaction module 112 may shorten or even eliminate the time restriction for a given seller between each transaction so that there is a sufficient liquid supply of chip offers at all times on the marketplace. In another embodiment, if transaction module 112 determines that the amount of chip offers currently outstanding is above a predetermined amount, transaction module 112 may lengthen the time restriction for a given seller between each transaction so that other sellers may be given the opportunity to sell chips as well.

It is to be appreciated that some or all of the above described restrictions may be implemented into the system and method of the present disclosure as desired. Also, it is to be appreciated that some or all of the above described restrictions may be implemented or enforced by controller 120, order module 110, and/or chip offer module 114 instead of transaction module 112. Additionally, it is to be appreciated that the above restrictions are only a small subset of the possible restrictions that may be implemented to create a fair and enticing marketplace environment for users.

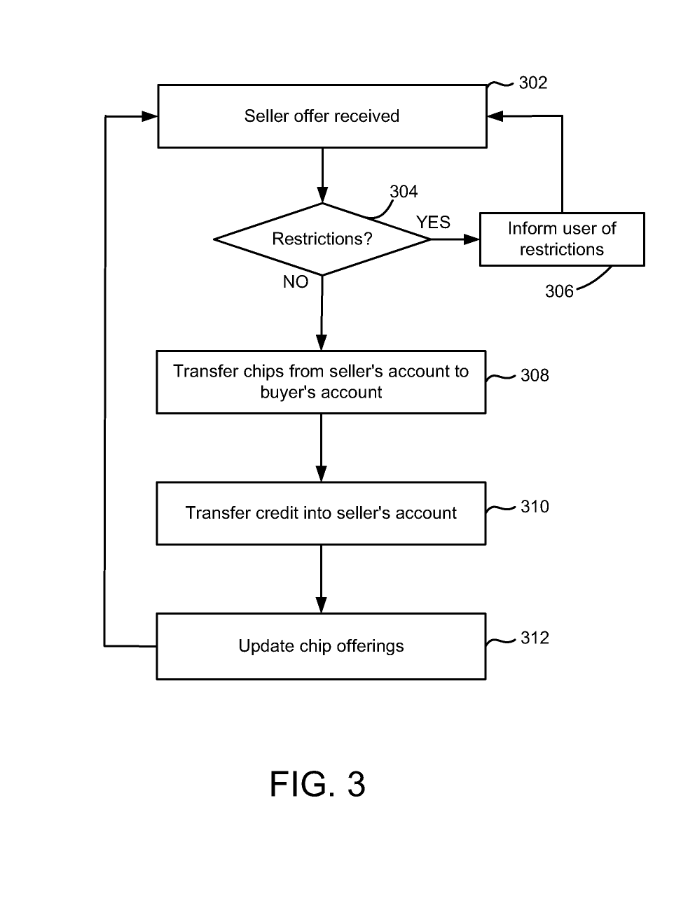

Turning now to FIG. 3, a flow chart of a method for a user to purchase chips from another user on a social casino gaming platform in accordance with an embodiment of the present disclosure is shown. Below the method illustrated in FIG. 3 will be described in relation to FIGS. 1-3.

As stated above, a user interested in buying chips from another user may view various seller chip offerings on table 204 in GUI 200. When a user finds an offering that interests the user, the user will press buy button 230 in the row corresponding to the order that is of interest to the user. After the buy button has been pressed, the buy request will be transmitted from user computing device 102 to communication interface 118 via network 104. From communication interface 118, the buy request will be transmitted to order module 110 in user marketplace 108 via controller 120 in step 302. From order module 110 the buy request will be transmitted to transaction module 112.

In step 304, transaction module 112 will determine if there are any restrictions preventing the buy request from being filled. For example, transaction module 112 will check player account module 116 to determine if the buying user has sufficient credit or money in his/her account to purchase the chips. If it is determined in step 304 that there is a restriction (i.e., the buying user has insufficient funds), transaction module 112 will not fill the buy request and will transmit a message to the user via communication interface 118 in step 306. The message will inform the user of the reason that the buy request was cancelled and prompt the user to add funds to the user's account if the user wishes to make a purchase. Then, in step 302, transaction module 112 will wait to receive another buy request.

Alternatively, if in step 304 it is determined that there are no restrictions associated with the buy request, transaction module 112 will transfer the purchased chips from the seller's account in player account module 116 to the buyer's account in player account module 116, in step 308. After the chips have been transferred from the seller's account to the buyer's account, transfer processor 112 will deduct the price or cost associated with the chips from the buyers account (i.e., debit the buyers account for the cost of the chips). In some embodiments, transaction processor 112 will then transfer the money deducted or debited from the buyer's account to the online social casino gaming company and transfer casino currency of the equivalent price of the money deducted from the buyers account and place casino currency in the seller's account in step 310. It is to be appreciated that the casino currency a seller accumulates may then be used to redeem rewards such as concert tickets, various products, etc.

In other embodiments, instead of receiving casino currency, the seller's account will be credited with a predetermined portion of the money debited from the buyer's account in step 310 and the online social casino gaming company will receive the remaining portion of the money deducted from the buyer's account. It is also to be appreciated that the percentage of the proceeds from the transaction that is transferred to the online social casino gaming company may be set as desired. In other embodiments, the seller's is credited with all of the money debited from the buyer's account, in step 310.

After, the buyer's and sellers accounts have been debited and credited with the correct amounts, transaction module 112 will update table 204 and remove the chip offering for the chips that have just been sold, in step 312. After table 204 has been updated, user marketplace 108 will wait for another buy request to be received in step 302.

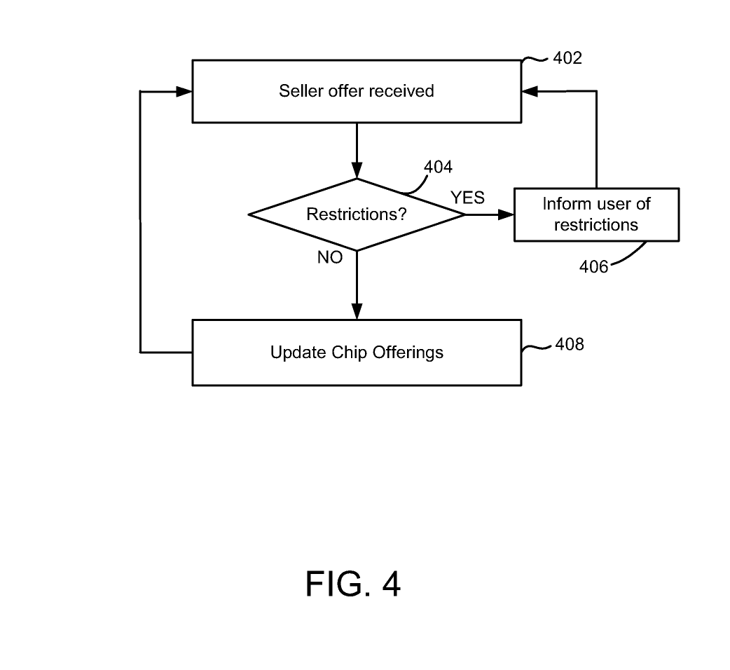

Turning now to FIG. 4, a flow chart of a method for a user to sell chips to another user on a social casino gaming platform in accordance with an embodiment of the present disclosure is shown. Below the steps in FIG. 4 will be described in relation to FIGS. 1, 2, and 4.

A user interested in selling their chips to other users may place a sell offer on their computing device 102. It is to be appreciated that in one embodiment the sell offer will include the amount of chips the seller would like to sell and the price the seller would like to sell the chips for. It is to be appreciated that in another embodiment the amount the seller can sell the chips for will be determined by the gaming platform and will be a set amount. When the user has placed the sell offer into their computing device 102, the sell offer will be transmitted via network 104 to user marketplace 108 where it will be received in chip offer module 114, in step 402. From chip offer module 114, the chips will be transmitted to transaction module 112.

Then, in step 404, transaction module 112 will determine if there are any restrictions associated with the sell offer. For example, as described above, there may be a restriction in effect that requires the seller to have spent a predetermined amount on chip purchases within a given time period to be able to sell chips to other users. Alternatively, transaction module 112 can determine if the seller has the number of chips being offered in the sellers account by checking player account module 116. It is to be appreciated that transaction module 112 can check for any of the restrictions listed above in the present disclosure.

If it is determined in step 404 that there is a restriction, transaction module 112 will cancel the sell offer and will transmit a message to the user via communication interface 118, in step 406. The message will inform the user of the reason that the sell offer was cancelled and prompt the user to make the necessary modifications if the user wishes to make a purchase. Then, in step 402, transaction module 112 will wait to receive another sell offer. Alternatively, if in step 404 it is determined that there are no restrictions associated with the sell offer, transaction module 112 will update table 204 to include the new sell offer, in step 408. It is to be appreciated that the information in columns 208 associated with the new sell offer can be obtained by processor 112 from player account module 116.

It is to be appreciated that there are many online social gaming casinos in the market that use a tiered-system, as described above. Furthermore, higher-tiered players that have spent considerable time and money on a particular online social gaming casino to achieve their high-tier status may be reluctant to try a different online social gaming casino because they will have to start playing at a lower tier and will lose perks attributable to their former higher-tier status. In an embodiment of the present disclosure, online social casino system 106 may be configured to determine a new player's tier in one or more other online social gaming casinos and grant the new player an equivalent tier status in the online social casino system 106. For example, when a new player signs up for online social casino system 106 and creates an account in player account module 116, player account module 116 may be configured to check the players account history on other online social gaming casino platforms. In one embodiment, the new player may provide the new player's credentials for other online social gaming casino platforms and player account module 116 may use the credentials to retrieve the new player's account history or information on the other online social gaming casino platforms to determine what the new player's tier status should be for the platform of online social gaming casino system 106. Once the new player's tier status is determined, player account module 116 may register the new user in the determined tier (e.g., being registered as a tier 3 player rather than a tier 1 player). In this way, long time players of competing online social casino gaming platforms will be more likely to try online gaming platform 106.

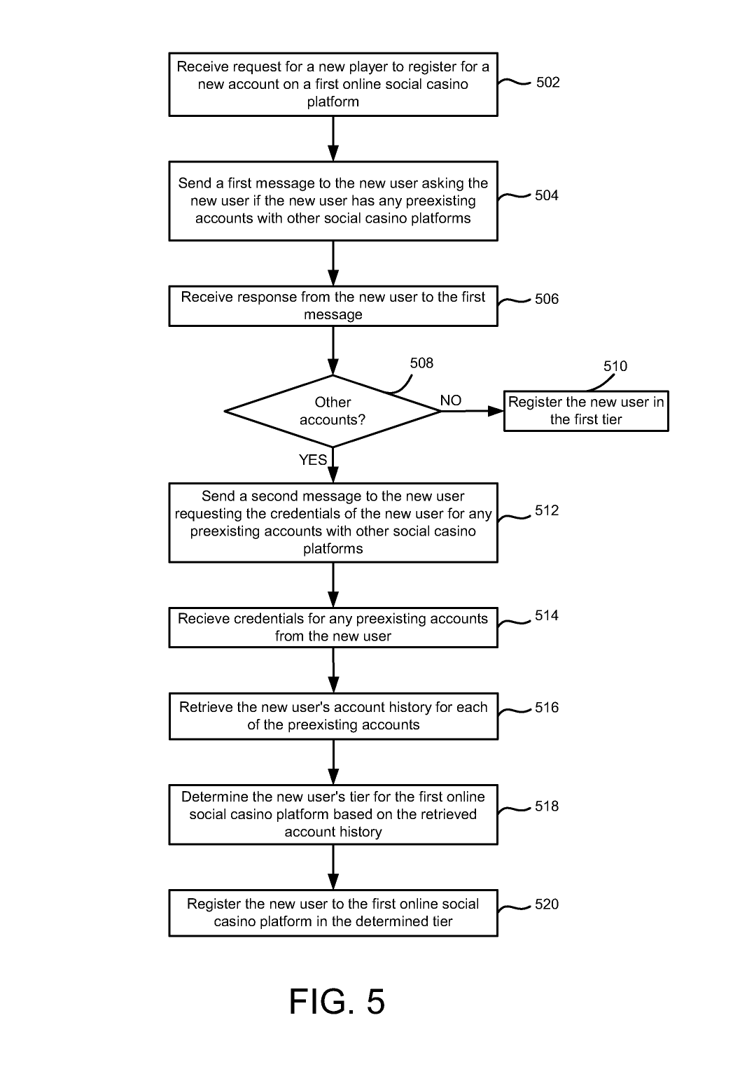

Referring to FIG. 5, a flow chart of a method for determining the tier status of a new player is shown in accordance with the present disclosure. Initially, player account module 116 receives a request from a new user (e.g., via computing device 102, Internet 104, communication interface 118, and controller 120) to register for a new account on a first online social casino 106, in step 502. In step 403, player account module 116 sends a first message to the new user (e.g., via controller 120, communication interface 118, and Internet 104) asking if the new user has any preexisting accounts with other social casino platforms (i.e., other than platform 106). In step 506, player account module 116 receives a response from the new user to the first message.

In step 508, player account module 116 determines, based on the response to the first message, if the new user has any preexisting accounts with other social casino platforms. If player account module 116 determines that the new user does not have any preexisting accounts with other social casino platforms, in step 508, player account module 116 will register the new user in the first tier for platform 106, in step 510. However, if, player account module 116 determines that the new user does have preexisting account with other social casino platforms, in step 508, player account module 116 will send a second message to the new user requesting the credentials (i.e., username and passwords) of the new user for the preexisting accounts the new user has with the other social casino platforms, in step 512.

In step 514, player account module 116 receives the new user's credentials for any preexisting accounts the new user had with other online social casino platforms. In step 516, player account module 116 retrieves the new users account history for each of the preexisting accounts using the credentials provided by the new user. In step 518, player account module 116 determines the new user's tier status for the first online social casino platform 106 based on the retrieved account history. It is to be appreciated that the tier status may be determined on many factors, for example, the amount of time user spent playing on the other online social casino platforms, the number of chips the user had purchased on the other online social casino platforms, etc. If the new user has accumulated enough total time spent on other online social casino platforms (where the threshold of time is chosen by platform 106) or has purchased enough total chips on the other online social casino platforms (where the threshold of time is chosen by platform 106), the determined new user's tier status will be a tier status above the first tier (e.g., the determined tier status may be the third tier). In step 520, player account module 116 registers the new user to the first online social casino platform 106 in the determined tier (e.g., the third tier).

In one embodiment of the present disclosure, a system for an online social casino platform is provided including: a communication interface coupled to a network, the network further coupled to a plurality of user computing devices, each user computing device associated with one of a plurality of users; a user account module configured to store information associated with each user of the plurality of users, wherein at least some of the information includes the number of chips and the amount of money each user of the plurality of users currently has in each user's account; a chip offer module configured to receive at least one sell offer from at least one first user of the plurality of users to sell chips belonging to the at least one first user, the at least one sell offer being for a first price; an order module configured to receive at least one buy order from at least one second user of the plurality of users to buy the chips being offered in the at least one sell offer by the at least one first user; and a transaction module configured to receive the at least one sell offer and the at least one buy order and determine if at least one restriction associated with the at least one sell offer and/or the at least one buy offer exists, and wherein if the transaction module determines that the at least one restriction does not exist, the transaction module completes a first transaction, the first transaction including the transaction module transferring the chips being offered in the at least one sell offer from a first user account associated with the first user to a second user account associated with the second user, the first and second account stored in the user account module, crediting the first account for the first price, and debiting the second account for the first price.

In another embodiment, the system provided includes, wherein if the transaction module determines at least one restriction exists, the transaction module sends a message to the at least one first user or the at least one second user informing the at least one first user or the at least one second user of the at least one restriction and that the first transaction was not completed.

In another embodiment, the system provided includes, wherein the at least one restriction is the at least one first user must have at least the same number of chips in the first account as the number of chips beings offered in the at least one sell offer at the time the buy order is received by transaction module.

In another embodiment, the system provided includes, wherein the at least one restriction is the at least one first user must have a predetermined number of chips in the first account in addition to the chips offered for sale in the at least one sell offer at the time the buy order is received by transaction module.

In another embodiment, the system provided includes, wherein the at least one restriction is the at least one second user must have at least the same amount of money in the second account as is needed to pay the first price of the at least one sell offer at the time the at least one buy order is received by transaction module.

In another embodiment, the system provided includes, wherein the at least one restriction is number of chips offering in the at least one sell offer being no greater than a predetermined number of chips.

In another embodiment, the system provided includes, wherein at least some of the information stored in the user account module includes a number of chips purchased made by each user of the plurality users and the at least one restriction is the at least one seller purchased a predetermined number of chips over a predetermined period of time.

In another embodiment, the system provided includes, wherein at least some of the information stored in the user account module includes the amount of money spent on chip purchases by each user of the plurality of users and the at least one restriction is the at least one seller spent a predetermined amount of money on chip purchases over a predetermined period of time.

In another embodiment, the system provided includes, wherein the plurality of users each belong to different tiers, the different tiers including at least a lower tier and an upper tier, and the at least one restriction is the at least one first user belongs to the upper tier.

In another embodiment, the system provided includes, wherein the user account module is further configured to receive a request from a new user to register for the online social casino platform and determine the new user's tier based on the new user's account history on other online social casino platforms.

In another embodiment, the system provided includes, wherein the user account module receives the player credentials of the new player for other online social casino platforms and retrieves the new user's account history information using player credentials of the new player for other online social casino platforms.

In another embodiment, the system provided includes, wherein the transaction module is further configured to restrict the at least one first user from submitting any additional sell offers for a predetermined period of time after the first transaction is completed.

In another embodiment, the system provided includes, wherein the transaction module is further configured to monitor the number of sell orders from all the users of the plurality of users that are currently outstanding and if the number of sell orders currently outstanding is below a predetermined threshold, the predetermined period of time after each transaction where the at least one first user is restricted from submitting any additional sell offers is lowered by a predetermined amount.

In another embodiment, the system provided includes, wherein if the number of sell orders currently outstanding is above the predetermined threshold, the predetermined period of time after each transaction where the at least one first user is restricted from submitting any additional sell offers is lowered by a predetermined amount.

In another embodiment, the system provided includes, further comprising a graphical user interface module that generates a graphical user interface to be displayed on each of the plurality of user computing devices, the graphical user interface includes a list of all outstanding sell offers and information relating to all the outstanding sell offers, the outstanding sell offers including the at least one sell offer.

In another embodiment, the system provided includes, wherein if the first transaction is completed, the graphical user interface is updated to remove the at least one sell offer.

In another embodiment, the system provided includes, wherein the graphical user interface also includes a selectable element associated with each sell offer, wherein when the selectable element is selected by the at least one first user, the at least one buy order is sent to the buy order module.

In another embodiment, the system provided includes, a gaming module configured to host a plurality of online social casino games.

In another embodiment, a method is provided including: receiving, by a chip offer module, at least one sell offer from at least one first user of a plurality of users to sell chips belonging to the at least one first user, the at least one sell offer being for a first price; receiving, by an order module, at least one buy order from at least one second user of the plurality of users to buy the chips being offered in the at least one sell offer by the at least one first user; receiving, by a transaction module, the at least one sell offer and the at least one buy order; determining, by the transaction module, if at least one restriction associated with the at least one sell offer and/or the at least one buy offer exists; and completing, by the transaction module, a first transaction if it is determined that the at least one restriction does not exist, the first transaction including the transaction module transferring the chips being offered in the at least one sell offer from a first user account associated with the first user to a second user account associated with the second user, crediting the first account for the first price, and debiting the second account for the first price.

In yet another embodiment, a method is provided including: receiving a request from a new user to register for a new account on a first online social casino platform; sending a first message to the new user asking the new user if the new user has any preexisting accounts with social casino platforms other than the first online social casino platform; receiving a response from the new user to the first message; registering the new user in a first player tier if the response indicates the new user does not have any preexisting accounts with other social casino platforms; sending a second message to the new user requesting the credentials of the new user for any preexisting accounts with other social casino platforms if the response to the first message indicates the new user does have any preexisting accounts with other social casino platforms; receiving the credentials for any preexisting accounts from the new user; retrieving the new user's account history for each of the preexisting accounts with other social casino platforms; determining the new user's tier for the first online social casino platform based on the retrieved account history, the determined tier being a tier above the first tier; and registering the new user to the first online social casino platform in the determined tier.

It is to be appreciated that the various features shown and described are interchangeable, that is a feature shown in one embodiment may be incorporated into another embodiment.

While non-limiting embodiments are disclosed herein, many variations are possible which remain within the concept and scope of the present disclosure. Such variations would become clear to one of ordinary skill in the art after inspection of the specification, drawings and claims herein. The present disclosure therefore is not to be restricted except within the spirit and scope of the appended claims.

Furthermore, although the foregoing text sets forth a detailed description of numerous embodiments, it should be understood that the legal scope of the present disclosure is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims. It should also be understood that, unless a term is expressly defined in this patent using the sentence

“As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

What is claimed is:

1. A system for an online social casino platform comprising:
a communication interface coupled to a network, the network further coupled to a plurality of user computing devices, each user computing device associated with one of a plurality of users;
a user account module configured to store information associated with each user of the plurality of users, wherein at least some of the information includes the number of chips and the amount of money each user of the plurality of users currently has in each user's account;
a chip offer module configured to receive at least one sell offer from at least one first user of the plurality of users to sell chips belonging to the at least one first user, the at least one sell offer being for a first price;
an order module configured to receive at least one buy order from at least one second user of the plurality of users to buy the chips being offered in the at least one sell offer by the at least one first user; and
a transaction module configured to receive the at least one sell offer and the at least one buy order and determine if at least one restriction associated with the at least one sell offer and/or the at least one buy offer exists, and
wherein if the transaction module determines that the at least one restriction does not exist, the transaction module completes a first transaction, the first transaction including the transaction module transferring the chips being offered in the at least one sell offer from a first user account associated with the first user to a second user account associated with the second user, the first and second account stored in the user account module, crediting the first account for the first price, and debiting the second account for the first price.

2. The system of claim 1, wherein if the transaction module determines at least one restriction exists, the transaction module sends a message to the at least one first user or the at least one second user informing the at least one first user or the at least one second user of the at least one restriction and that the first transaction was not completed.

3. The system of claim 1, wherein the at least one restriction is the at least one first user must have at least the same number of chips in the first account as the number of chips beings offered in the at least one sell offer at the time the buy order is received by transaction module.

4. The system of claim 1, wherein the at least one restriction is the at least one first user must have a predetermined number of chips in the first account in addition to the chips offered for sale in the at least one sell offer at the time the buy order is received by transaction module.

5. The system of claim 1, wherein the at least one restriction is the at least one second user must have at least the same amount of money in the second account as is needed to pay the first price of the at least one sell offer at the time the at least one buy order is received by transaction module.

6. The system of claim 1, wherein the at least one restriction is number of chips offering in the at least one sell offer being no greater than a predetermined number of chips.

7. The system of claim 1, wherein at least some of the information stored in the user account module includes a number of chips purchased made by each user of the plurality users and the at least one restriction is the at least one seller purchased a predetermined number of chips over a predetermined period of time.

8. The system of claim 1, wherein at least some of the information stored in the user account module includes the amount of money spent on chip purchases by each user of the plurality of users and the at least one restriction is the at least one seller spent a predetermined amount of money on chip purchases over a predetermined period of time.

9. The system of claim 1, wherein the plurality of users each belong to different tiers, the different tiers including at least a lower tier and an upper tier, and the at least one restriction is the at least one first user belongs to the upper tier.

10. The system of claim 9, wherein the user account module is further configured to receive a request from a new user to register for the online social casino platform and determine the new user's tier based on the new user's account history on other online social casino platforms.

11. The system of claim 10, wherein the user account module receives the player credentials of the new player for other online social casino platforms and retrieves the new user's account history information using player credentials of the new player for other online social casino platforms.

12. The system of claim 1, wherein the transaction module is further configured to restrict the at least one first user from submitting any additional sell offers for predetermined period of time after the first transaction is completed.

13. The system of claim 12, wherein the transaction module is further configured to monitor the number of sell orders from all the users of the plurality of users that are currently outstanding and if the number of sell orders currently outstanding is below a predetermined threshold, the predetermined period of time after each transaction where the at least one first user is restricted from submitting any additional sell offers is lowered by a predetermined amount.

14. The system of claim 13, wherein if the number of sell orders currently outstanding is above the predetermined threshold, the predetermined period of time after each transaction where the at least one first user is restricted from submitting any additional sell offers is lowered by a predetermined amount.

15. The system of claim 1, further comprising a graphical user interface module that generates a graphical user interface to be displayed on each of the plurality of user computing devices, the graphical user interface includes a list of all outstanding sell offers and information relating to all the outstanding sell offers, the outstanding sell offers including the at least one sell offer.

16. The system of claim 15, wherein if the first transaction is completed, the graphical user interface is updated to remove the at least one sell offer.

17. The system of claim 1, wherein the graphical user interface also includes a selectable element associated with each sell offer, wherein when the selectable element is selected by the at least one first user, the at least one buy order is sent to the buy order module.

18. The system of claim 1, further comprising a gaming module configured to host a plurality of online social casino games.

19. A method comprising:
receiving, by a chip offer module, at least one sell offer from at least one first user of a plurality of users to sell chips belonging to the at least one first user, the at least one sell offer being for a first price;
receiving, by an order module, at least one buy order from at least one second user of the plurality of users to buy the chips being offered in the at least one sell offer by the at least one first user;
receiving, by a transaction module, the at least one sell offer and the at least one buy order;
determining, by the transaction module, if at least one restriction associated with the at least one sell offer and/or the at least one buy offer exists; and
completing, by the transaction module, a first transaction if it is determined that the at least one restriction does not exist, the first transaction including the transaction module transferring the chips being offered in the at least one sell offer from a first user account associated with the first user to a second user account associated with the second user, crediting the first account for the first price, and debiting the second account for the first price.

20. A method comprising:
receiving a request from a new user to register for a new account on a first online social casino platform;
sending a first message to the new user asking the new user if the new user has any preexisting accounts with social casino platforms other than the first online social casino platform;
receiving a response from the new user to the first message;
registering the new user in a first player tier if the response indicates the new user does not have any preexisting accounts with other social casino platforms;
sending a second message to the new user requesting the credentials of the new user for any preexisting accounts with other social casino platforms if the response to the first message indicates the new user does have any preexisting accounts with other social casino platforms;
receiving the credentials for any preexisting accounts from the new user;
retrieving the new user's account history for each of the preexisting accounts with other social casino platforms;
determining the new user's tier for the first online social casino platform based on the retrieved account history, the determined tier being a tier above the first tier; and
registering the new user to the first online social casino platform in the determined tier.
